(19) United States
(12) Patent Application Publication
(10) Pub. No.: US 2014/0236682 A1
(43) Pub. Date: Aug. 21, 2014

(54) METHOD FOR CONDUCTING PERFORMANCE REVIEWS

(71) Applicant: David GREEN, Bangor, ME (US)

(72) Inventor: David GREEN, Bangor, ME (US)

(73) Assignee: Nurse Anesthesia of Maine, LLC

(21) Appl. No.: 13/770,823

(22) Filed: Feb. 19, 2013

(51) Int. Cl. G06Q 10/06

(52) U.S. Cl. CPC G06Q 10/06398
USPC 705/7.42

(57) ABSTRACT

A performance management method for the assessment of personnel within an organization by the use of survey applications and internet technology to allow personnel to be assessed by other personnel in an efficient and consistent manner resulting in the production of usable data that benefits the assessed personnel and the organization as a whole.

### BACKGROUND OF THE INVENTION

1. Technical Field

The present invention relates generally to computerized collection and processing of data. More particularly, the present invention relates to a method for obtaining data concerning the performance of personnel of an organization through the use of online surveys completed by assessing personnel, then processing that data into meaningful formats for use in reviewing the performance of the assessed personnel, raising the levels of performance for both individuals and the organization, and developing the next generation of leaders.

2. Description of Prior Art

Evaluation of personnel of an organization is an important and valuable exercise for better management of the personnel and the organization as a whole. It can take many forms: supervisor evaluations of subordinate employees, peer-to-peer evaluations, so-called “360” evaluations whereby personnel are evaluated by supervisors, subordinates, and peers, and many other variations. The logistics of conducting evaluations is also varied, with evaluations being conducted in written form, as part of face to face meetings, through electronic means, or some combination of these or other formats. The use put to completed evaluations also varies, with evaluation results being used to develop, promote, discipline, reassign, train, or otherwise affect the evaluated personnel and the management of the organization.

Traditional performance evaluation processes tend to be provided by managers for their employees annually. The feedback data may be objective (based on measurable criteria such as productivity and quality standards), subjective (based on the manger's perceptions and observations), or a combination of objective and subjective criteria. The problem of providing quality performance feedback is even more difficult when the manager and employee work in different locations and do not have regular face to face contact with each other. This can be caused by the manager managing multiple locations or through “telecommuting” where employees work from home or another remote location.

This type of performance feedback often suffers from drawbacks, causing dissatisfaction for both the manager and the employee and failing to achieve the primary goal of improving the performance of the individuals and the organization. Common problems with traditional performance management processes include: managers in an organization not having a consistent process or consistent criteria for evaluating staff; managers not having good data for giving raises, bonuses and promotions; managers and leaders not getting feedback on their own performance; feedback to employees being inconsistent and not helpful for growth and development; performance evaluation data being stored in manual formats, making analysis of trends difficult and time consuming; and the process not being perceived as being fair. These problems then can lead to: inconsistencies in compensation and growth opportunities between departments; morale issues with managers and employees; stress and conflicts between managers and employees, and between managers; performance and productivity issues; the best employees being overlooked for promotions; Increased employee turnover; long term human resource trends being difficult to track and analyze; and the organization being at a competitive disadvantage.

In overcoming these drawbacks, the best evaluation techniques are those that instill confidence in the evaluating parties, whereby it is recognized that the evaluations will produce valuable and useable information, and in the evaluated parties, whereby it is appreciated that the evaluations will be fair, objective, accurate, and helpful.

Notwithstanding the foregoing, too often personnel evaluations do not meet the goals of resulting in valuable and useable information through a process that is fair, objective, accurate, and helpful. There may be a lack of knowledge of how to best conduct personnel evaluations, or lack of structure, or lack of tools.

It is therefore an objective of the present invention to provide a method for performing personnel evaluations that is standardized but directed to the unique needs of the organization, takes advantage of advanced technologies to facilitate both human input and information processing, and is accepted by all participants of achieving the organizations goals.

It is a further objective of the present invention to provide a method for performing personnel evaluations that uses an internet based survey application for obtaining data.

It is yet a further objective of the present invention to provide a method for performing personnel evaluations that is consistent across an organization and is a “total system”.

It is yet a further objective of the present invention to provide a method for performing personnel evaluations that assesses the most important criteria for the organization.

It is yet a further objective of the present invention to provide a method for performing personnel evaluations that provides tangible comparative data reports to the assessed personnel as part of the personnel evaluations.

It is yet a further objective of the present invention to provide a method for performing personnel evaluations that collects multiple sources of data in preparation for performance evaluations.

It is yet a further objective of the present invention to provide a method for performing personnel evaluations where the evaluators facilitate a performance dialog using robust data.

It is yet a further objective of the present invention to provide a method for performing personnel evaluations where all leaders and employees get “actionable” feedback that helps them develop and improve.

It is yet a further objective of the present invention to provide a method for performing personnel evaluations that rewards and promotes the best people.

It is yet a further objective of the present invention to provide a method for performing personnel evaluations that identifies low performers and helps them improve or to leave the organization.

It is yet a further objective of the present invention to provide a method for performing personnel evaluations that is perceived as being fair.

It is yet a further objective of the present invention to provide a method for performing personnel evaluations that positions an organization's human resources talent for growth.

It is yet a further objective of the present invention to provide a method for performing personnel evaluations that is flexible and enables regular process improvements.

It is yet a further objective of the present invention to provide a method for performing personnel evaluations that stores comparative data reports for future consideration.

It is yet a further objective of the present invention to provide a method for performing personnel evaluations where long term human resource trends can be analyzed and improvements developed.

It is yet a further objective of the present invention to provide a method for performing personnel evaluations that can tie into a strategic plan and assess an organization's and individual's progress relative to the plan.

It is yet a further objective of the present invention to provide a method for performing personnel evaluations that is relatively inexpensive to manage.

Other objectives of the present invention will be readily apparent from the description that follows.

### SUMMARY OF THE INVENTION

The method disclosed by the present invention is a total system starting with the development of the skills and competencies to be measured, followed by a determination of who will be evaluated and who will be doing the evaluation, then the collection of data, the compilation of that data, the provision of that data to the evaluated personnel, and the creation of individual development plans for each evaluated personnel and a strategic Talent Management Plan for the organization as a whole. The data collection and compilation processes use inexpensive technology with a short learning curve, and is easily adaptable to meet the needs of individual organizations.

In one aspect of the present invention the method uses an internet based survey application to solicit information about the assessed personnel. This provides an easy to use means for obtaining both objective and subjective information, and allows for simple processing of objective data into easily understood reports and graphs. The reports and graphs are then used in evaluative meetings with the assessed personnel in order to develop individual development plans as well as organization-wide management plans.

In another aspect of the present invention the method stores the results from personnel assessment for future use, for example, in year over year evaluative comparisons.

Other features and advantages of the invention are described below.

### DESCRIPTION OF THE DRAWINGS

FIG. 1 depicts a schematic representation of one embodiment of the method of the present invention.

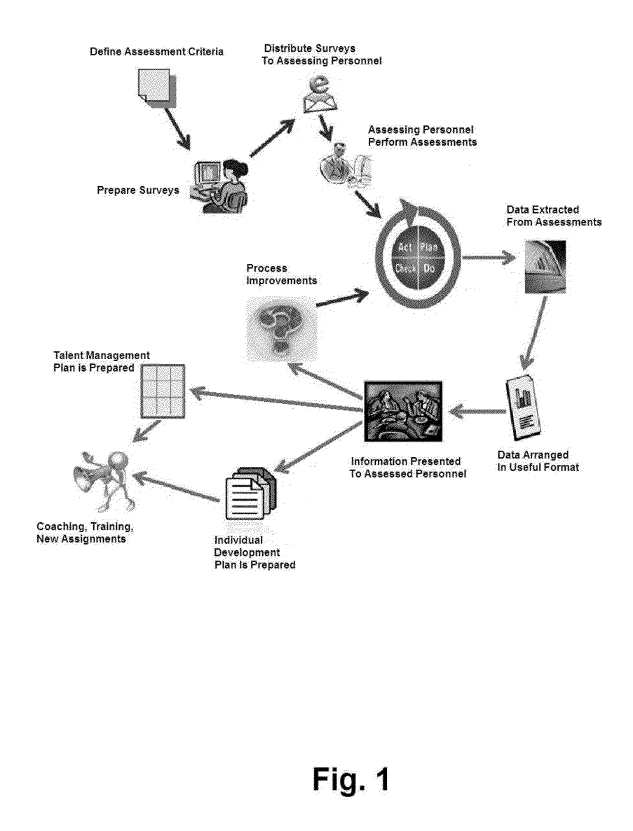

FIG. 2 depicts a flow chart of another embodiment of the method of the present invention.

FIG. 3 depicts a flow chart of another embodiment of the method of the present invention.

FIG. 4 depicts a flow chart of yet another embodiment of the method of the present invention.

FIG. 5 depicts a flow chart of yet another embodiment of the method of the present invention.

FIG. 6 depicts a flow chart of yet another embodiment of the method of the present invention.

### DETAILED DESCRIPTION OF THE INVENTION

The present invention discloses a method of evaluating the performance of personnel associated with an organization. The organization may be a commercial enterprise, a charitable society, a small business, a partnership, or any other entity that has associated with it personnel, whereby the personnel may be owners, leaders, managers, employees, independent contractors, or other persons who have affiliations with the organization.

The personnel, which may include all of the personnel of the organization or only a subset thereof, are divided into two groups: assessing personnel and assessed personnel. The assessing personnel are personnel capable of performing an assessment of other personnel, including themselves (i.e., capable of performing a self-assessment). The assessed personnel are those personnel to be assessed by the assessing personnel. There may be one or more personnel in the assessing personnel group and one or more personnel in the assessed personnel group. In one embodiment of the method the two groups of personnel will not overlap. This may be seen in a traditional supervisor-subordinate model, where only supervisors are assessing personnel and only subordinates are assessed personnel. In other embodiments there may be partial overlap between the groups, where some of the assessing personnel are also assessed and some of the assessed personnel also perform assessments. This may be seen in a hierarchical employment situation, where mid-level supervisors assess subordinates and are also themselves assessed by upper management. So-called “360” evaluations may also involve overlapping groups, where supervisors and subordinates evaluate each other and their peers. In some embodiment there may be complete overlap between the groups, where each personnel member is both a member of the assessing personnel group and of the assessed personnel group. This may be seen in peer-run organizations or partnerships.

One embodiment of the method of the present invention comprises the following steps A through I:

A. Determine the competencies, skills, and/or behaviors of personnel to be assessed;

B. Create a survey using a computer-based or internet-based survey application, said survey having questions directed to the competencies, skills, and/or behaviors to be assessed as determined in Step A;

C. Create a list of one or more assessing personnel;

D. Create a list of one or more assessed personnel;

E. Contact each of the assessing personnel listed in the list created in Step C, providing each said assessing personnel access to the survey created in Step B and an identification of one or more assessed personnel listed in the list created in Step D;

F. Complete an instantiation of the survey for each assessed personnel by having each of the assessing personnel answer said survey's questions for each of the assessed personnel to be assessed by said assessing personnel, whereby said answers are associated with the assessed personnel and stored by the survey application;

G. Extract data from the answers from completed instantiations of the survey stored in Step F;

H. Create one or more displays, each said display set forth in one or more human readable formats, each said display created from data extracted in Step G, with at least one display associated with each assessed personnel, and each said display including survey data associated with said assessed personnel and including data computed from the aggregate of survey data of all assessed personnel; and

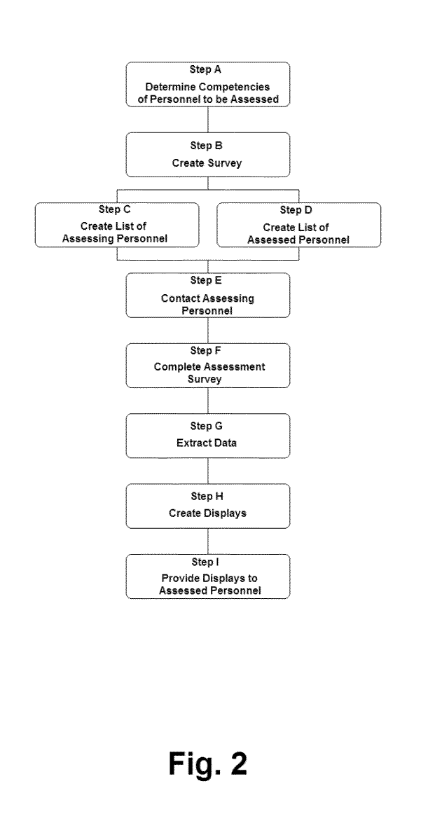

I. Provide the one or more displays associated with each assessed personnel created in Step H to each said assessed personnel for review. See FIG. 2.

Step B is to be performed after Step A. Steps C and D may be performed at any time relative to each other and relative to Steps A and B. Steps E through I are performed in the order listed, with Step E to be performed after Steps A through D are completed.

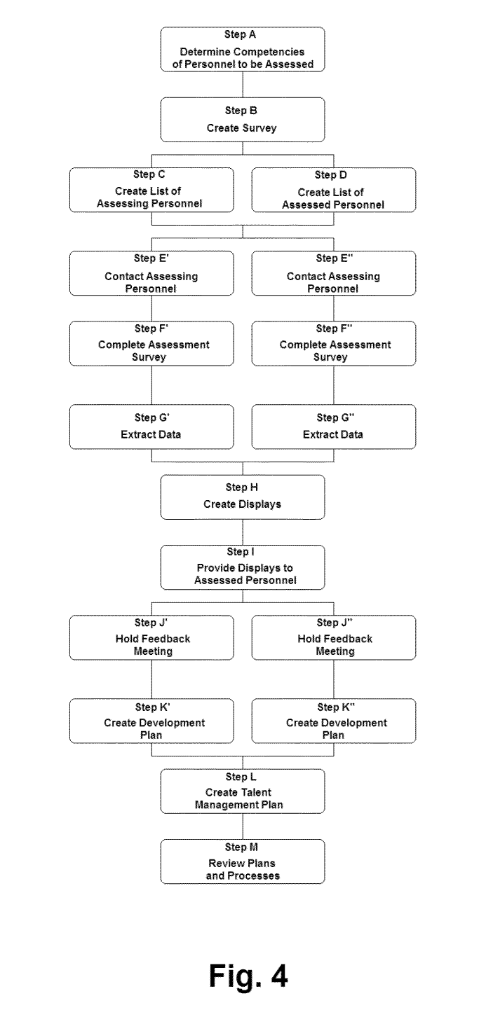

In one embodiment, Step E is comprised of Substeps E′ and E″, Step F is comprised of Substeps F′ and F″, and Step G is comprised of Substeps G′ and G″. Substep E′ comprises all of the actions of Step E, but only with regard to one or more but fewer than all of the assessing personnel and for one or more but fewer than all of the assessed personnel. Substep E″ comprises all of the actions of Step E, but only as applied to assessing personnel and assessed personnel not acted upon by application of Substep E′. Likewise, Substep F′ comprises all of the actions of Step F, but only with regard to one or more but fewer than all of the assessing personnel and for one or more but fewer than all of the assessed personnel, Substep F″ comprises all of the actions of Step F, but only as applied to assessing personnel and assessed personnel not acted upon by application of Substep F′, Substep G′ comprises all of the actions of Step G, but only with regard to one or more but fewer than all of the assessing personnel and for one or more but fewer than all of the assessed personnel, and Substep G″ comprises all of the actions of Step G, but only as applied to assessing personnel and assessed personnel not acted upon by application of Substep G′. See FIG. 4.

In such embodiment, Substeps E′, F′, and G′ are performed in that order, with Substep E′ performed after Steps A through D are completed. Likewise, Substeps E″, F″, and G″ are performed in that order, with Substep E″ performed after Steps A through D are completed. See FIG. 4. However, Substeps E′ through G′, collectively, may be performed in any order relative to Substeps E″ through G″, collectively. This allows, for example, for a subset of assessing personnel to be contacted, to complete instantiations of the survey for some of the assessed personnel for whom they are responsible, and for the extraction of data from the answers from those completed instantiations of the survey, all without regard to the timing of these steps by other assessing personnel or even for the same assessing personnel with regard to other assessed personnel for who that assessing personnel is responsible.

With regard to the particulars of Step A, namely, the determination of the competencies, skills, and/or behaviors of personnel to be assessed, this step can be performed in any number of ways. The organization may have historical information that adequately sets forth the criteria. It may designate a person or convene a special committee or task force to develop the criteria. It may purchase criteria from a third-party entity that specializes in such criteria development. It may combine any of the foregoing, or determine the criteria by other means. The important concept is that the criteria should be specific to the organization, its personnel, and its goals.

By way of example, the determination of the competencies, skills, and/or behaviors of personnel to be assessed should involve the asking of a series of questions that cover the “what” (the technical or managerial or administrative skills needed for the work being done by the personnel) and the “how” (how to assess the emotional intelligence of personnel or the ability to work well with others). Being clear about what is important to the organization and what is not will help narrow down the criteria to the most important few. Sample questions may include references to work skills, organizational skills, punctuality, neatness, attitude, customer interactions, productivity, professionalism, approachability, business acumen, empathy, composure, integrity, conflict management skills, problem solving ability, ambition, and other traits. Each individual organization will have a mix of generic and unique criteria that are important to it, and the determination of the competencies, skills, and/or behaviors of personnel to be assessed should take into account these criteria.

With regard to the particulars of Step B, namely, the creation of a survey using a computer-based or internet-based survey application directed to the competencies, skills, and/or behaviors to be assessed as determined in Step A, any one of the readily available survey applications currently available may be used. A typical survey application consists of software that runs on a computer and that has a user interface which displays questions and provides for the input of answers to those questions. Answers provided are then stored, with or without identification of the assessing personnel, though with identification of the assessed personnel. The answers may be multiple choice, true/false, or free text. A typical survey question may set forth an inquiry as to an observable trait of the assessed personnel, for example, punctuality, and the answer may comprise a series of selectable responses that range from “always” to “sometime” to “never”. Numerical values may be assigned to the answers. This allows for “scoring” of the answers, which can then be used to compare each assessed personnel against others.

In one embodiment of the method survey application is the SurveyMonkey® software application. This application allows for users to design a survey by inputting the questions into a web-based template using an internet browser, deciding whether the corresponding answers are multiple choice or free text, and if multiple choice deciding the range of possible answers. The completed survey is stored on an off-site computer server and is accessible through the internet. Survey takers are given an internet link (a URL address), usually provided by email, and simply executing the link brings up an instantiation of the survey on an internet browser. Once answers are provided by the user they are stored on an off-site computer server. The survey administrator can gather statistics on the survey (for example, how many surveys were fully completed, partially completed, not started, etc.) and can extract the data stored by the survey application. Other survey applications may also be used.

With regard to the particulars of Step C, namely, the creation of a list of one or more assessing personnel, this may be done in any number of ways, depending on the type of evaluation that is to be performed, as described above. Once the assessing personnel are identified, a physical list should be created that records identifying criteria, such as their names, or employee numbers, or a unique identifier that is used only for the purpose of the evaluation if anonymity is desired. The list itself could be hard copy, such as a paper record, or electronic. In one embodiment the assessing personnel are entered into an Excel® spreadsheet, which associates each assessing personnel's name with an email address. Using an Excel® spreadsheet has the advantage of ease of use, wide-spread availability, and flexibility. Other electronic facilities can also be used for the list of assessing personnel.

With regard to the particulars of Step D, namely, the creation of a list of one or more assessed personnel, this may be done in a similar manner as the creation of the list of assessing personnel. Similarly, once the assessed personnel are identified, a physical list should be created that records identifying criteria, including their names, employee numbers, unique identifier, etc. The list itself could be hard copy, such as a paper record, or electronic. In one embodiment the assessed personnel are entered into an Excel® spreadsheet.

In some embodiments the list of assessing personnel and the list of assessed personnel might be recorded in a single physical list. In such embodiments an Excel® spreadsheet might be used that lists both assessing personnel and assessed personnel. In these embodiments each entry for an assessing personnel may have associated with it one or more unique identifiers of associated assessed personnel. Thus, if each of the assessed personnel has associated with it a unique identification number, the identification numbers of the assessed personnel for whom each assessing personnel is responsible will be associated with that assessing personnel. As an example, a row entry in the spreadsheet for assessed personnel may include in the first column the assessed personnel's name and in the second column the assessed personnel's unique numeric identifier. A row entry in the spreadsheet for assessing personnel may include in the first column the assessing personnel's name, in the second column the assessing personnel's email address, and in the third through n columns a numeric identifier corresponding to each of the assessed personnel for whom the assessing personnel is responsible. In embodiments where the lists of assessing personnel and assessed personnel overlap, there may be only a single type of row entry, with the first column including the personnel's name, the second column including the personnel's unique numeric identifier, the third column including the personnel's email address, and the fourth through n columns including the unique numeric identifier corresponding to each of the personnel to be assessed by that assessing personnel.

With regard to the particulars of Step E, namely the contacting of each of the assessing personnel listed and providing each with access to the survey created in Step B and an identification of one or more assessed personnel listed in the list created in Step D, this may be done in any number of ways. Each of the assessing personnel may be contacted orally, or in writing through hard copy correspondence, or by telephone. In the preferred embodiment each assessing personnel will be contacted by email. In such embodiments the email will include a URL address to a website where the survey application can be found, or preferably a link to the website directly accessing the survey application. The email will also include the names or other identifiers of each of the personnel to be assessed.

In some embodiments the one or more personnel who are to be assessed by each of the assessing personnel in Step E are randomly selected from the personnel listed in the list of assessed personnel created in Step D. The random selection of personnel to be evaluated occurs in those circumstances where each assessing personnel assesses fewer than all of the assessed personnel. Randomization can be achieved in any practical sense. One method, in which the assessed personnel are associated with unique numeric identifiers, involves the use of a random number generator to select the assessed personnel.

With regard to the particulars of Step F, namely the completion of an instantiation of the survey for each assessed personnel by each of the assessing personnel, this step is accomplished by each of the assessing personnel answering the questions set forth in an instantiation of the survey for each of the assessed personnel to be assessed by that assessing personnel, using the survey application. The assessing personnel first accesses the survey application. In the preferred embodiments the survey application is internet-based and is accessed over the internet by using the URL provided in Step E or by clicking on the link provided in an email in Step E. The survey application then opens in a web browser on the assessing personnel's computer and the assessing personnel initiates an instantiation of the survey for one of the assessed personnel on the list of assessed personnel provided in Step E. The assessing personnel completes the instantiation of the survey by answering all of the questions in the survey, then saves the results. The survey application then stores the information entered by the assessing personnel. The assessing personnel then initiates an instantiation of the survey for another of the assessed personnel on the list of assessed personnel provided in Step E, repeating all of the steps for that personnel, and continues for all of the assessed personnel on the list provided in Step E.

The data that is stored by the survey application may be stored on one or more computer-based storage devices located within the organization. Alternatively, it may be stored on one or more computer-based storage devices located remote from the organization and accessible via the internet.

With regard to the particulars of Step G, namely the extraction of data from the answers from completed instantiations of the survey stored in Step F, this can be done in any number of ways. Where the data is stored by the survey application in a database, a database access application can be used to access the data. In the preferred embodiments, the survey application itself will provide data access functionality, to be employed by authorized users. By accessing the survey application, the authorized user can initiate an extraction of the data, uploading the data into whatever form is most convenient. In some embodiments the survey application uploads processed data, such as data formatted into graphs by the survey application or data aggregated by the survey application. In other embodiments the survey application uploads raw data into another software application, to be further processed. An example of another software application that can be used to receive the raw data from the survey application is an Excel® spreadsheet. In yet other embodiments the survey application uploads both processed data and raw data into another software application.

With regard to the particulars of Step H, namely the creation of one or more displays from data extracted in Step G, each of the displays is presented in a human readable format. At least one display is associated with each assessed personnel, and each such display also includes survey data associated with the aggregate of all assessed personnel. Thus, for a given assessed personnel, the associated display shows the numerical scoring for that assessed personnel for each of the assessment criteria, as well as an average scoring for all of the assessed personnel for each of the same assessment criteria. This allows comparison of the assessed personnel against all of the other assessed personnel as a group. In one embodiment the displays of the data created in Step H are set forth in paper form. In the preferred embodiments the displays of the data created in Step H are set forth in electronic form. These may be portable document format (“pdf”) files, PowerPoint® presentations, Word® files, images files, emails, or the like. The data itself may be displayed in graphical format, tabular format, textual format, or a combination of one or more of these or other formats.

With regard to the particulars of Step I, namely the provision of one or more displays associated with each assessed personnel created in Step H to each said assessed personnel for review, where the displays are in paper format the physical copies may be delivered to the assessed personnel. This may be in hand, by U.S. mail, by courier, or by any other suitable means. Where the displays are in electronic format the displays may be stored in a CD-ROM disk, a flash drive, or other portable storage media and delivered in the same manner as a paper format display. In one embodiment the electronic format displays are provided by email to the appropriate assessed personnel.

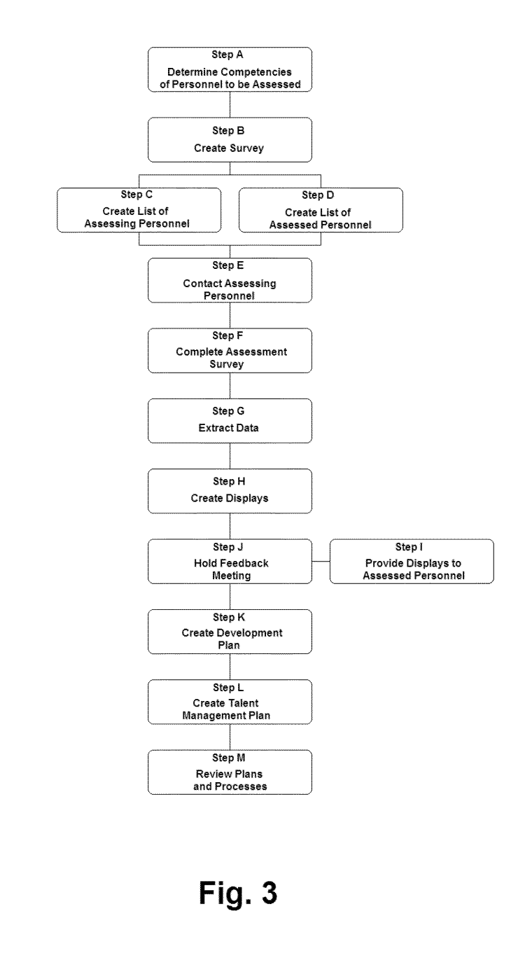

In the preferred embodiments, the method of the present invention is further comprised of Step J, which is to hold a feedback meeting with each assessed personnel using the one or more displays created in Step H and provided to that assessed personnel in Step I. See FIG. 3. Step J is to be performed after Step I (where the displays are communicated to the assessed personnel in advance) or contemporaneously with Step I (where the displays are communicated to the assessed personnel during the feedback meeting). See FIG. 3. Step J may be performed face-to-face, or by telephone, or by video conference, or by other appropriate means. Such feedback meetings can be a part of a larger, ongoing review or may constitute the entirety of the review. During the feedback meeting the displays created in Step H should be reviewed by and discussed with the assessed personnel. Overall performance and performance relative to the aggregate of all assessed personnel should be discussed. Strengths evident from the data should be encouraged, and weaknesses evident from the data should be addressed. A typical feedback meeting may incorporate the following substeps: (i) set the stage, by describing what the meeting is all about, how the meeting will be conducted, where the data to be discussed came from, etc.; (ii) present the feedback data created in Step H and discuss the overall performance for each question, the performance relative to the average for the peer group, the assessed personnel's strengths, and areas identified for development; (iii) have the assessed personnel summarize the data and comment on both positive and negative aspects, and acknowledge the areas for development; (iv) discuss career development goals; (v) discuss any other “annual” material the company may need to cover; (vi) determine any next steps, such as a follow up meeting on training and development, approval for time and money for training, etc.; and (vii) sign off on the evaluation by manager and employee.

There should be “no suprises” during the feedback meeting of Step J. The feedback meeting of Step J should not be a substitute for ongoing feedback (positive and negative) over the course of the year. Such meetings are best conducted in a relaxed environment, with an emphasis on emphasizing the positive, connecting performance to company goals, and with a development focus for the areas for development.

In yet another embodiment, the method of the present invention is further comprised of Steps J and K, where Step J is as described above and Step K is the creation of a development plan for each assessed personnel based on the results of the feedback meeting for that assessed personnel held in Step J. Step K is to be performed after Step J. The development plan should be tailored to the individual assessed personnel, though it may contain certain generic aspects. It may involve individual coaching, mentoring, new assignments, training opportunities (both within and without the organization), goals for lateral or vertical advancement, and the like. Further feedback meetings based on the development plan may be undertaken periodically, to assess progress. The development plan may be created during the feedback meeting of Step J, or the assessed personnel may do some research after the feedback meeting of Step J to obtain information necessary for creation of the plan. A typical development plan may include structure for (i) performance coaching; (ii) follow up meetings on training and development; (iii) check-ins as needed from the discussion; (iv) approval for time and money for training; (v) mentoring; (vi) new assignments; (vii) leadership opportunities outside the organization; and (viii) if needed, a performance improvement plan for low performers.

In yet another embodiment where both Steps J and K are present, Step J is comprised of Substeps J′ and J″ and Step K is comprised of Substeps K′ and K″. Substep J′ comprises all of the actions of Step J, but only with regard to one or more but fewer than all of the assessing personnel and for one or more but fewer than all of the assessed personnel. Substep J″ comprises all of the actions of Step J, but only as applied to assessing personnel and assessed personnel not acted upon by application of Substep F. Likewise, Substep K′ comprises all of the actions of Step K, but only with regard to one or more but fewer than all of the assessing personnel and for one or more but fewer than all of the assessed personnel, and Substep K″ comprises all of the actions of Step K, but only as applied to assessing personnel and assessed personnel not acted upon by application of Substep K′. See FIG. 4.

In such embodiment, Substeps J′ and K′ are performed in that order, with Substep J′ performed after Step I is completed. Likewise, Substeps J″ and K″ are performed in that order, with Substep J″ performed after Step I is completed. See FIG. 4. However, Substeps J′ and K′, collectively, may be performed in any order relative to Substeps J″ and K″, collectively. This allows, for example, for a subset of assessed personnel to participate in feedback meetings and then for there to be development plans created for those assessed personnel, without regard to the timing of these steps for other assessed personnel.

In yet another embodiment of the present invention, the method is further comprised of Steps J, K, and L, with Steps J and K as described above and Step L being the creation of a talent management plan from a summary of all development plans created in Step K. Step L is to be performed after Step K. A talent management plan should be structured to help position all personnel within the organization relative to their performance and potential for future performance, so that decisions can be made for the organization as a whole given its existing personnel. Thus, if strong performers are identified the talent management plan may indicate that further development of the strong performers for leadership positions is warranted. If no such strong performers are identified the talent management plan may indicate that hiring personnel from outside the organization is necessary. If a significant number of weak performers are identified the talent management plan may indicate that the organization should establish an institutional training program; if only a few weak performers are identified the talent management plan may indicate that those weak performers be terminated. It is important to recognize that every talent management plan is to be tailored to the needs of the organization, and while there may be similarities from organization to organization in each talent management plan developed, it is just as likely that two entirely different talent management plans may be developed by two very similar organizations having similar personnel.

One way to implement a talent management plan is to assess each personnel on the twin axes of performance and potential. Each axis may be further divided into high, medium, and low. Thus, each assessed personnel will fall into one of nine categories: high potential/high performer; high potential/medium performer; high potential/low performer; medium potential/high performer; medium potential/medium performer; medium potential/low performer; low potential/high performer; low potential/medium performer; and low potential/low performer. To be considered high potential, the employee needs to have both the ability and desire to operate at a higher level in the company. Performance is assessed on objective criteria. Assessed personnel who are deemed high potential/high performer should be targeted for accelerated development opportunities. Assessed personnel who are deemed low potential/low performer may be targeted for counseling or termination.

In yet another embodiment of the present invention, the method is further comprised of Steps J, K, L, and M, with Steps J, K, and L as described above and Step M being acting on the talent management plan by reviewing personnel development, training, coaching, and assignment plans and making changes thereto if indicated from the talent management plan created in Step L and from the development plans created in Step K. Step M is to be performed after Step L. See FIG. 3.

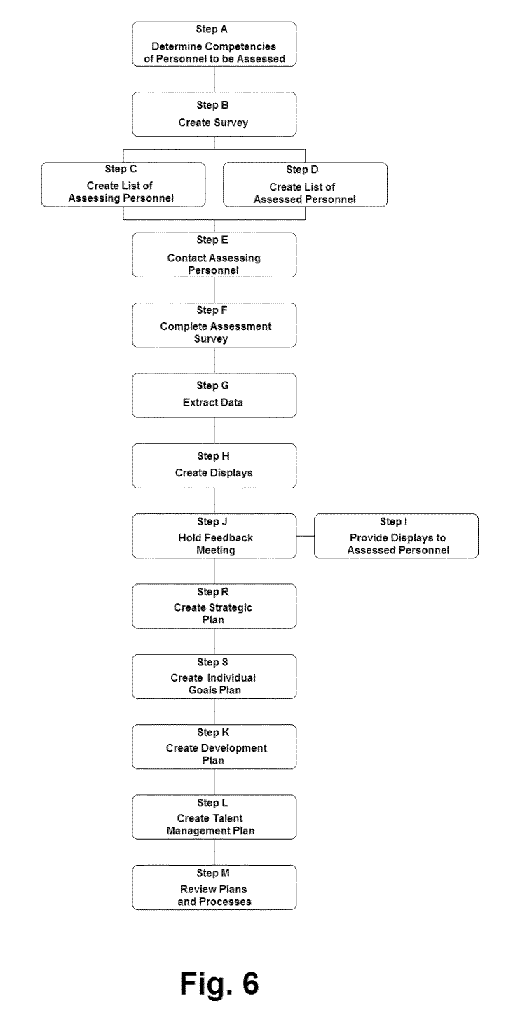

In yet another embodiment of the present invention, the method is further comprised of Steps J, K, and R, with Steps J and K as described above and Step R being the creation of a strategic plan for the organization as a whole or for a department of the organization, with the strategic plan being based on the results of the feedback meeting for that assessed personnel held in Step J. See FIG. 6. Step R is to be performed after Step J. In one embodiment the strategic plan is created before the development plan created in Step K, and informs the creation of the development plan in Step K. In another embodiment the strategic plan is created independently of the development plan created in Step K. A strategic plan should be structured to take into account the assessments of the personnel of the organization or the division.

In yet another embodiment of the present invention, the method is further comprised of Steps J, K, R, and S, with Steps J, K, and R as described above and Step S being the creation of an individual goals plan based on the strategic plan created in Step R. See FIG. 6. Step S is to be performed after Step R and before Step K. The individual goals plan informs the creation of the development plan in Step K. The individual goals plan should be structured to assist the assessed personnel in identifying appropriate goals for personal development which also furthers the goals of the organization.

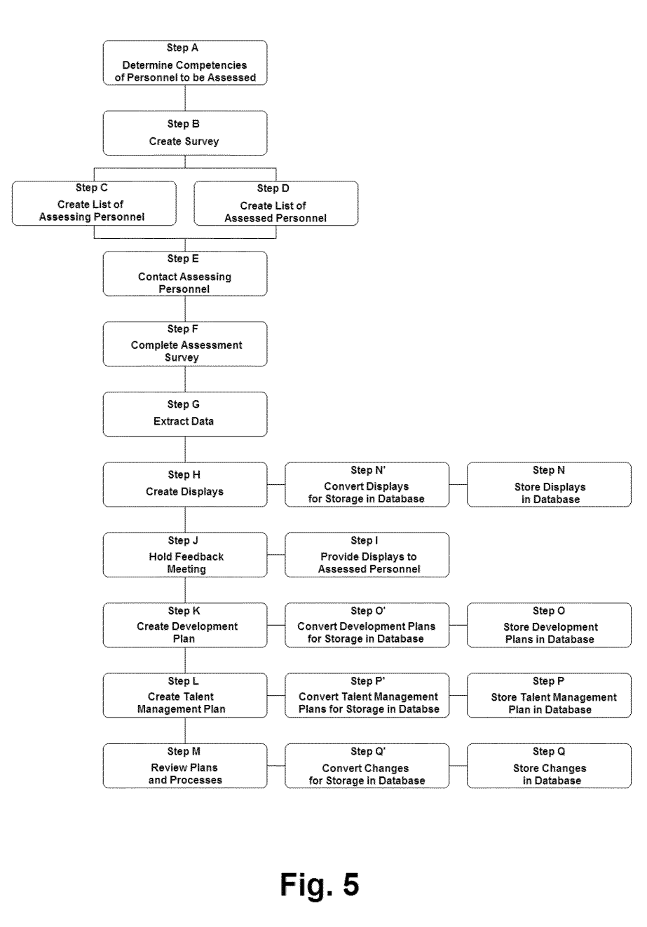

In yet another embodiment of the present invention in which Step H is performed, the method is further comprised of Step N, whereby Step N comprises storing the one or more displays created in Step H in a database for future access and review. Step N is performed at any time after Step H. Where the one or more displays created in Step H are in a form not amenable to database storage, the method further comprises Step N′, which is to convert the one or more displays created in Step H into a format allowing for storage in the database. Step N′ is performed at any time after Step H and before Step N. See FIG. 5.

In yet another embodiment of the present invention in which Step K is performed, the method is further comprised of Step O, whereby Step O comprises storing the development plan for each assessed personnel created in Step K in a database for future access and review. Step O is performed at any time after Step K. Where the development plans created in Step K are in a form not amenable to database storage, the method further comprises Step O′, which is to convert the development plans created in Step K into a format allowing for storage in the database. Step O′ is performed at any time after Step K and before Step O. See FIG. 5.

In yet another embodiment of the present invention in which Step L is performed, the method is further comprised of Step P, whereby Step P comprises storing the talent management plan created in Step L in a database for future access and review. Step P is performed at any time after Step L. Where the talent management plan created in Step L is in a form not amenable to database storage, the method further comprises Step P′, which is to convert the talent management plan created in Step L into a format allowing for storage in the database. Step P′ is performed at any time after Step L and before Step P. See FIG. 5.

In yet another embodiment of the present invention in which Step M is performed, the method is further comprised of Step Q, whereby Step Q comprises storing the changes to personnel development, training, coaching, and assignment plans made in Step M in a database for future access and review. Step Q is performed at any time after Step M. Where the changes to personnel development, training, coaching, and assignment plans made in Step M are in a form not amenable to database storage, the method further comprises Step Q′, which is to convert the changes to personnel development, training, coaching, and assignment plans made in Step M into a format allowing for storage in the database. Step Q′ is performed at any time after Step M and before Step Q. See FIG. 5.

Modifications and variations can be made to the disclosed embodiments of the method of the present invention without departing from the subject or spirit of the invention as defined in the following claims.

I claim:

1. A method of evaluating the performance of personnel associated with an entity, said personnel comprised of one or more assessing personnel and one or more assessed personnel, each of said one or more assessing personnel capable of performing an assessment of one or more assessed personnel, and each of said one or more assessed personnel being the subject of an assessment by one or more assessing personnel,
said method comprising the following steps:
A. Determine competencies, skills, and/or behaviors of personnel to be assessed;
B. Create a survey using a computer-based or internet-based survey application, said survey having questions directed to the competencies, skills, and/or behaviors to be assessed as determined in Step A;
C. Create a list of one or more assessing personnel;
D. Create a list of one or more assessed personnel;
E. Contact each of the assessing personnel listed in the list created in Step C, providing each said assessing personnel access to the survey created in Step B and an identification of one or more assessed personnel listed in the list created in Step D;
F. Complete an instantiation of the survey for each assessed personnel by having each of the assessing personnel access the survey created in Step B and then answer said survey's questions for each of the assessed personnel to be assessed by said assessing personnel, whereby said answers are associated with the assessed personnel and stored by the survey application;
G. Extract data from the answers from completed instantiations of the survey stored in Step F;
H. Create one or more displays, each said display set forth in one or more human readable formats, each said display created from data extracted in Step G, with at least one display associated with each assessed personnel, and each said display including survey data associated with said assessed personnel and including data computed from the aggregate of survey data of all assessed personnel; and
I. Provide the one or more displays associated with each assessed personnel created in Step H to each said assessed personnel for review;
whereby Step B is to be performed after Step A; Steps C and D may be performed at any time relative to each other and relative to Steps A and B; and Steps E through I are performed in the order listed, with Step E to be performed after Steps A through D are completed.

2. The method of claim 1 comprising the further step:
J. Hold a feedback meeting with each assessed personnel using the one or more displays created in Step H and provided to said assessed personnel in Step I;
whereby Step J is to be performed after Step I.

3. The method of claim 1 comprising the further step:
J. Hold a feedback meeting with each assessed personnel using the one or more displays created in Step H and provided to said assessed personnel in Step I;
whereby Step I is to be performed during the performance of Step J.

4. The method of claim 3 comprising the further step:
K. Create a development plan for each assessed personnel based on the feedback meeting for said assessed personnel held in Step J;
whereby Step K is to be performed after Step J.

5. The method of claim 4 comprising the further step:
L. Create a talent management plan from a summary of all development plans created in Step K;
whereby Step L is to be performed after Step K.

6. The method of claim 5 comprising the further step:
M. Review personnel development, training, coaching, and assignment plans and make changes thereto if indicated from the talent management plan created in Step L and from zero or more of the development plans created in Step K;
whereby Step M is to be performed after Step L.

7. The method of claim 1 wherein Step E is comprised of Substeps E′ and E″, Step F is comprised of Substeps F′ and F″, and Step G is comprised of Substeps G′ and G″,
with Substeps E′ through G′ comprising the actions of Steps E through G, respectively, but only with regard to one or more but fewer than all of the assessing personnel and for one or more but fewer than all of the assessed personnel, and with Substeps E″ through G″ comprising the actions of Steps E through G, respectively, but only as applied to assessing personnel and assessed personnel not acted upon by application of Substeps E′ through G′,
whereby Substeps E′ through G′ are performed in the order listed, with Substep E′ to be performed after Steps A through D are completed,
Substeps E″ through G″ are performed in the order listed, with Substep E″ to be performed after Steps A through D are completed, and
Substeps E′ through G′, collectively, are performed in any order relative to Substeps E″ through G″, collectively.

8. The method of claim 4 wherein Step J is comprised of Substeps J′ and J″ and Step K is comprised of Substeps K′ and K″,
with Substeps J′ through K′ comprising the actions of Steps J through K, respectively, but only with regard to one or more but fewer than all of the assessed personnel, and with Substeps J″ through K″ comprising the actions of Steps J through K, respectively, but only as applied to assessed personnel not acted upon by application of Substeps J′ through K′,
whereby Substeps J′ through K′ are performed in the order listed, with Substep J′ to be performed after Step I is completed,
Substeps J″ through K″ are performed in the order listed, with Substep J″ to be performed after Step I is completed, and
Substeps J′ through K′, collectively, are performed in any order relative to Substeps J″ through K″, collectively.

9. The method of claim 1 wherein one or more of the assessing personnel are also assessed personnel and one or more of the assessed personnel are also assessing personnel, and the list of assessed personnel created in Step D contains one or more personnel from the list of assessing personnel created in Step C, and the list of assessing personnel created in Step C contains one or more personnel from the list of assessed personnel created in Step D.

10. The method of claim 1 wherein all of the assessing personnel are also assessed personnel and the list of assessed personnel created in Step D contains all of the personnel from the list of assessing personnel created in Step C.

11. The method of claim 1 wherein all of the assessed personnel are also assessing personnel and the list of assessing personnel created in Step C is the same list as the list of assessed personnel created in Step D.

12. The method of claim 1 whereby the list of assessing personnel created in Step C comprises both supervising personnel and subordinate personnel of the entity and the list of assessed personnel created in Step D comprises both supervising personnel and subordinate personnel of the entity.

13. The method of claim 1 wherein the one or more assessed personnel who are to be assessed by each of the assessing personnel in Step E are randomly selected from the personnel listed in the list of assessed personnel created in Step D.

14. The method of claim 1 whereby the one or more displays of the data of Step H includes data displayed in one or more of the following group of formats: graphical format, tabular format, textual format.

15. The method of claim 1 whereby the one or more displays of the data of Step H is provided in Step I in paper form.

16. The method of claim 1 whereby the one or more displays of the data of Step H is provided in Step I in electronic form.

17. The method of claim 1 whereby the survey created in Step B is accessible by assessing personnel in Step F via the internet.

18. The method of claim 1 whereby the answers to the instantiations of the survey stored in Step F are stored on one or more computer-based storage devices located at the entity.

19. The method of claim 1 whereby the answers to the instantiations of the survey stored in Step F are stored on one or more computer-based storage devices located remote from the entity and accessible via the internet.

20. The method of claim 1 comprising the further step:
N. Store the one or more displays created in Step H in a computer database;
whereby Step N is to be performed after Step H.

21. The method of claim 20 comprising the further step:
N′. Convert the one or more displays created in Step H into a format allowing for storage of same in the computer database;
whereby Step N′ is to be performed after Step H and before Step N.

22. The method of claim 4 comprising the further step:
O. Store the development plan for each assessed personnel created in Step K in a computer database;
whereby Step O is to be performed after Step K.

23. The method of claim 22 comprising the further step:
O′. Convert the development plans created in Step K into a format allowing for storage of same in the computer database;
whereby Step O′ is to be performed after Step K and before Step O.

24. The method of claim 5 comprising the further step:
P. Store the talent management plan created in Step L in a computer database;
whereby Step P is to be performed after Step L.

25. The method of claim 24 comprising the further step:
P′. Convert the talent management plan created in Step L into a format allowing for storage of same in the computer database;
whereby Step P′ is to be performed after Step L and before Step P.

26. The method of claim 6 comprising the further step:
Q. Store the changes to personnel development, training, coaching, and assignment plans made in Step M in a computer database;
whereby Step Q is to be performed after Step M.

27. The method of claim 26 comprising the further step:
Q′. Convert the changes to personnel development, training, coaching, and assignment plans made in Step M into a format allowing for storage of same in the computer database;
whereby Step Q′ is to be performed after Step M and before Step Q.

28. The method of claim 4 comprising the further step:
R. Create a strategic plan based on the feedback meeting for said assessed personnel held in Step J;
whereby Step R is to be performed after Step J.

29. The method of claim 28 comprising the further step:
S. Create an individual goals plan based on the strategic plan created in Step R;
whereby Step S is to be performed after Step R and before Step K.
